(19) United States
(12) Patent Application Publication
(10) Pub. No.: US 2024/0007001 A1
(43) Pub. Date: Jan. 4, 2024

(54) VOLTAGE CONVERTER, METHOD FOR MANUFACTURING SUCH A VOLTAGE CONVERTER, METHOD FOR CONTROLLING A VOLTAGE CONVERSION CIRCUIT AND CORRESPONDING COMPUTER PROGRAM

(71) Applicant: Valeo eAutomotive France SAS, Cergy (FR)

(72) Inventors: Larbi BENDANI, Cergy (FR); Nadjib BOUZIDI, Cergy (FR); Mathieu DIHAL, Cergy (FR); Sebastien LECOINTRE, Cergy (FR)

(73) Assignee: Valeo eAutomotive France SAS, Cergy (FR)

(21) Appl. No.: 18/246,862

(22) PCT Filed: Sep. 29, 2021
(86) PCT No.: PCT/EP2021/076866

§ 371 Date: Mar. 28, 2023

(30) Foreign Application Priority Data
Sep. 29, 2020 (FR) 2009929

(51) Int. Cl. H02M 3/335; H02M 1/00

(52) U.S. Cl. CPC H02M 3/33515; H02M 1/0009; H02M 1/0058; H02M 3/33571

(57) ABSTRACT

A voltage converter includes a voltage conversion circuit having an inverter including at least one switching arm having a high-side switch and a low-side switch, a resonant tank, a rectifier and an output capacitor. A device for controlling the switches is designed to alternate a phase in which the control device opens the first of the switches and closes a second, and a phase in which the control device opens the second of the switches and closes the first, the control device being designed to provide a dead time between two consecutive phases. The voltage converter further includes a device for measuring an electrical signal of the voltage conversion circuit and the control device is designed to determine, from the measured electrical signal, a crossing instant of the resonance current and the auxiliary current and to calculate a duration of the dead time from the crossing instant.

The present invention relates to a voltage converter, a method for manufacturing such a voltage converter, a method for controlling a voltage conversion circuit and a corresponding computer program.

A voltage converter is known from the prior art that is of the type comprising:
a voltage conversion circuit comprising:
   an inverter designed to provide a square wave voltage from a direct input voltage, the inverter comprising at least one switching arm comprising a high-side switch and a low-side switch, connected together at a midpoint designed to introduce the square wave voltage;
   a resonant tank comprising a resonance capacitor, a resonance inductor and an auxiliary inductor;
   a rectifier connected to the auxiliary inductor for rectifying an alternating current exiting the resonant tank in order to provide a rectified current;
   an output capacitor designed to provide a direct output voltage from the rectified current; and
a device for controlling the switches designed to alternate a phase in which the control device opens a first one of the switches and closes a second one of the switches, and a phase in which the control device opens the second one of the switches and closes the first one of the switches, with the control device being designed to provide, between two consecutive phases, a dead time during which the two switches are open.

The dead time aims to allow the voltage at the terminals of the switch to be closed to reach zero in order to carry out zero voltage switching (ZVS).

According to a first technique for determining the dead time, a map is previously recorded, which provides the dead time duration as a function of the switching frequency of the switching arm. The disadvantage of this first technique is that the dead time duration is determined for the worst operating case, so that, in practice, in most cases it is longer than necessary.

According to a second technique for determining the dead time, the midpoint voltage is measured and the dead time is stopped when this measured voltage is cancelled. The disadvantage of this second technique is that the midpoint voltage can make untimely transitions to zero that risk generating an incorrect value for the dead time.

There is thus a need to provide a converter that allows at least some of the aforementioned problems and constraints to be overcome.

Therefore, a voltage converter of the aforementioned type is proposed, characterized in that it further comprises a device for measuring an electrical signal of the voltage conversion circuit and in that the control device is designed to determine, from the measured electrical signal, a crossing instant of the resonance current and of the auxiliary current and to compute a dead time duration from the crossing instant.

Thus, by virtue of the invention, a measurement is used, which allows better precision than with a map, and a measurement of the midpoint voltage is not necessary.

Optionally, the voltage converter further comprises a transformer having a magnetizing inductor on a primary of the transformer and the auxiliary inductor comprises the magnetizing inductor.

Also optionally, the electrical signal is the rectified current.

Also optionally, the control device is designed to determine the crossing instant by detecting an instant when the rectified current is cancelled.

Also optionally, the electrical signal is the alternating current.

Also optionally, the control device is designed to determine the crossing instant by detecting an instant when the alternating current changes sign.

Also optionally, the voltage converter comprises capacitors respectively connected parallel to the switches.

A method is also proposed for manufacturing a voltage converter according to the invention, comprising:
obtaining a range of switching frequencies for the switching arm;
determining values for the capacitors such that for each capacitor, after opening the side switch opposite this capacitor, this capacitor is discharged before the resonance current crosses the magnetizing current on the or even on all the switching frequencies of the obtained range; and
manufacturing the voltage converter with capacitors with the determined values.

A method is also proposed for controlling a voltage conversion circuit comprising:
an inverter designed to provide a square wave voltage from a direct input voltage, the inverter comprising at least one switching arm comprising a high-side switch and a low-side switch, connected together at a midpoint designed to introduce the square wave voltage;
a resonant tank comprising a resonance capacitor, a resonance inductor and an auxiliary inductor;
a rectifier connected to the auxiliary inductor for rectifying an alternating current exiting the resonant tank in order to provide a rectified current;
an output capacitor designed to provide a direct output voltage from the rectified current;
   characterized in that it comprises:
controlling the switches in order to alternate a phase in which the control device opens a first one of the switches and closes a second one of the switches, and a phase in which the control device opens the second one of the switches and closes the first one of the switches, with the control device being designed to provide, between two consecutive phases, a dead time during which the two switches are open;
measuring an electrical signal of the voltage conversion circuit;
determining, from the measured electrical signal, a crossing instant of the resonance current and of the auxiliary current; and
computing a dead time duration from the crossing instant.

A computer program is also proposed that is downloadable from a communication network and/or is recorded on a computer-readable medium, characterized in that it comprises instructions for executing the steps of a method as claimed in claim 9, when said program is executed on a computer.

The invention will be better understood by means of the following description, which is provided solely by way of an example and with reference to the accompanying drawings, in which:

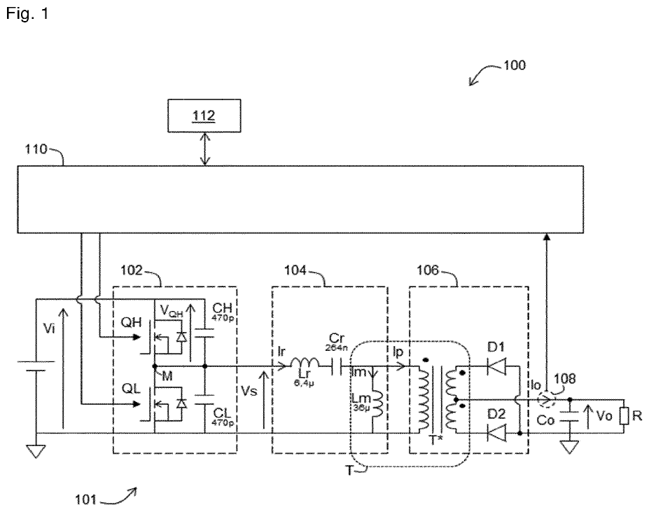

FIG. 1 is an electrical diagram of a first example of a voltage converter according to the invention;

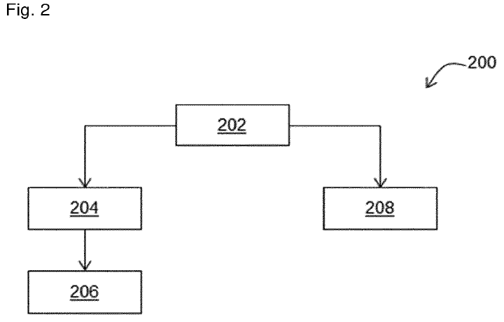

FIG. 2 is a block diagram illustrating the steps of a method for controlling a voltage conversion circuit, according to one embodiment of the invention;

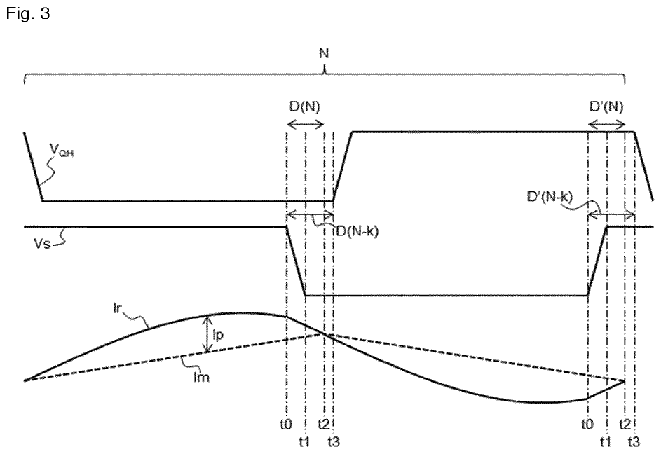

FIG. 3 is a timing diagram illustrating the evolution over time of several electrical quantities of the voltage converter of FIG. 1;

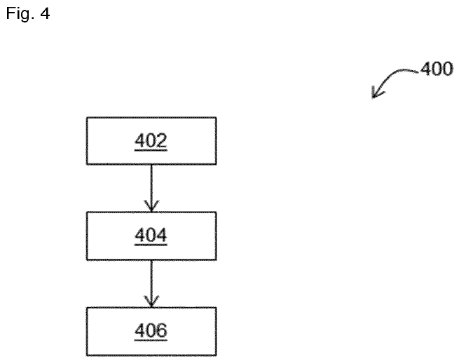

FIG. 4 is a block diagram illustrating the steps of a method for manufacturing a voltage converter, according to one embodiment of the invention;

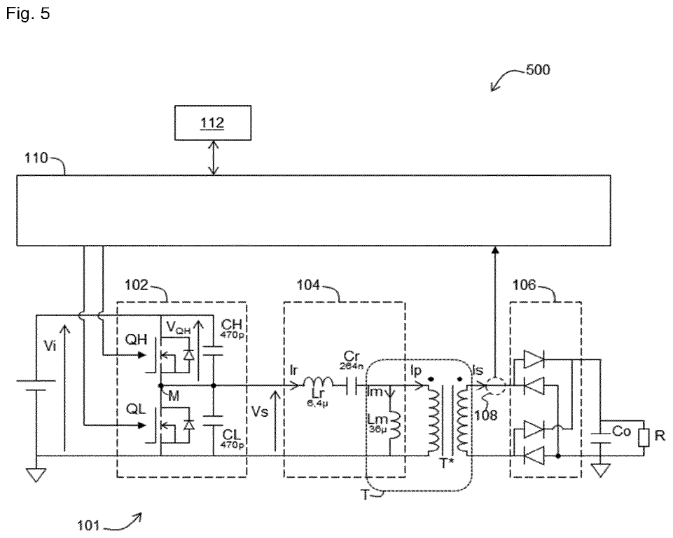

FIG. 5 is an electrical diagram of a second example of a voltage converter according to the invention; and

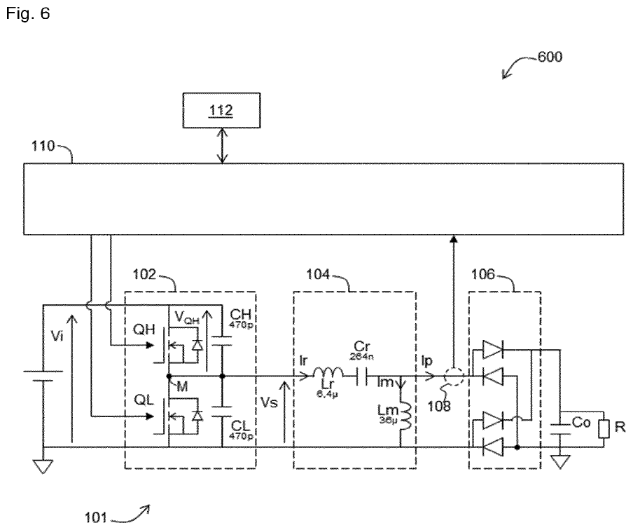

FIG. 6 is an electrical diagram of a third example of a voltage converter according to the invention.

With reference to FIG. 1, an example of a voltage converter 100 implementing the invention will now be described.

The voltage converter 100 firstly comprises a voltage conversion circuit 101.

The voltage conversion circuit 101 comprises an inverter 102 designed to provide a square wave voltage Vs from a direct input voltage Vi. The inverter 102 comprises at least one switching arm. In the example described, the inverter 102 is a half-bridge inverter and comprises a single switching arm. The switching arm comprises a high-side switch QH and a low-side switch QL, connected together at a midpoint M and designed to receive the direct input voltage Vi. As will be described in detail hereafter, the switches QH, QL are designed to be controlled in opposition so that the midpoint M provides the square wave voltage Vs. In the example described, the square wave voltage Vs alternately equals zero and the direct input voltage Vi.

The switches QH, QL are, for example, transistor switches, such as metal oxide gate field effect transistors, generally denoted using the acronym MOSFET (Metal Oxide Semiconductor Field Effect Transistor).

Alternatively, the inverter 102 could be a full-bridge inverter comprising two switching arms for providing a square wave voltage Vs alternately equaling the direct input voltage Vi and the opposite thereof.

The voltage conversion circuit 101 further comprises a resonant tank 104 designed to provide an alternating current Ip from the square wave voltage Vs. The resonant tank 104 is connected parallel to the low-side switch QL and firstly comprises a resonance capacitor Cr and a resonance inductor Lr in series with each other and designed to be traversed by a resonance current Ir. The resonant tank 104 further comprises, on the one hand, an auxiliary inductor Lm designed to be traversed by an auxiliary current Im and, on the other hand, two branches starting on either side of the auxiliary inductor Lm in order to provide the alternating current Ip.

The resonant tank 104 has a resonance frequency Fr defined by the resonance capacitor Cr and the resonance inductor Lr and equaling:

$$Fr = \frac{1}{2 π \sqrt{Lr \cdot Cr}}$$

The voltage conversion circuit 101 further comprises a rectifier 106 connected to the branches of the resonant tank in order to be connected parallel to the auxiliary inductor Lm and designed to rectify the alternating current Ip in order to provide a rectified current lo.

In the example described, the voltage conversion circuit 101 comprises a transformer T. The transformer T can be modelled by an ideal transformer T* comprising a primary and a secondary and a magnetizing inductor on the primary. The auxiliary inductor Lm comprises this magnetizing inductor. As a result, throughout the remainder of the description of this embodiment, the expressions “auxiliary inductor” and “magnetizing inductor” will be used interchangeably, as will the expressions “auxiliary current” and “magnetizing current”. Furthermore, the alternating current Ip is thus a current entering the primary of the transformer T. As a result, throughout the remainder of the description of this embodiment, the expressions “alternating current” and “primary current” will be used interchangeably.

Still with reference to the example described, the secondary of the transformer T is a center tap secondary and has two ends around this center tap. The rectifier 106 comprises two diodes D1, D2, respectively connected to the ends of the secondary of the transformer T, in the same direction relative to these ends. In the example described, the diodes D1, D2 are conductive in the directions of the ends. Thus, the center tap provides the rectified current lo. The rectifier 106 thus comprises, in the example described, the ideal transformer T* and the diodes D1, D2. The secondary of the transformer also may not have a center tap, and will then have a diode bridge connected thereto. The invention also can be applied with a current-reversible full-bridge. This is particularly the case when the voltage converter is two-way. The rectifier can then comprise transistors, in particular mounted as a full-bridge. Furthermore, an inductor and a capacitor can be connected in series with the secondary of the transformer.

The voltage conversion circuit 101 further comprises an output capacitor Co connected between, on one side, the center tap and, on the other side, the diodes D1, D2, in order to provide a direct output voltage Vo from the rectified current lo.

A charge R then can be connected parallel to the output capacitor Co in order to receive the output voltage Vo and thus be electrically powered.

The voltage converter 100 further comprises a device 108 for measuring an electrical signal of the voltage conversion circuit 101, preferably a current. In the example described, the measuring device 108 is designed to measure the rectified current lo.

The voltage converter 100 further comprises a device 110 for controlling the switches QH, QL, designed to alternate a phase in which the control device 110 opens a first one of the switches QH, QL and closes a second one of the switches, and a phase in which the control device 110 opens the second one of the switches QH, QL and closes the first one of the switches. The control device 110 is also designed to provide, between two consecutive phases, a dead time during which the two switches QH, QL are open at the same time.

A control cycle therefore comprises two consecutive phases and defines a switching frequency Fc equal to the inverse of the duration of the cycle. The output voltage Vo depends on the switching frequency Fc. Thus, the control device 110 is designed to vary the switching frequency Fc, for example, to slave the output voltage Vo to a predefined value.

The control device 110 is designed to determine, from the measured electrical signal (the rectified current Is in the example described), a crossing instant of the resonance current Ir and of the magnetizing current Im and to determine an end of the dead time from the crossing instant. An embodiment of this determination of the crossing instant will be described in further detail hereafter with reference to FIGS. 2 and 3.

The voltage converter 100 further comprises a memory 112 coupled to the control device 110.

With reference to FIGS. 2 and 3, an example of a method 200 for operating the voltage converter 100, and more specifically the measurement device 108 and the control device 110, will now be described.

Initially, it is assumed that the high-side switch QH is closed and that the low-side switch QL is open (first phase of the cycle). Thus, the low-side capacitor CI has all the input voltage Vi and the resonance current Ir completely passes through the high-side switch QH. It is also assumed that the resonance current Ir is greater than the magnetizing current Im, and that the magnetizing inductor Lm receives a substantially constant voltage derived from the output voltage Vo, so that the magnetizing current Im increases substantially linearly.

In the example described, the switching frequency Fc is greater than the resonance frequency Fr, such that the voltage conversion circuit 101 operates as a buck converter.

At an instant t0, the control device 110 controls the opening of the high-side switch QH, while keeping the low-side switch QL open (step 202). The instant t0 is therefore the start instant of the dead time.

At this moment, the resonance current Ir therefore originates from the capacitors CH, CL, which causes the high-side capacitor CH to charge and the low-side capacitor C1 to discharge. Thus, the square wave voltage Vs decreases until it reaches zero at an instant t1.

At an instant t2, the resonance current Ir crosses the magnetizing current Im. This crossing is reflected by the fact that the rectified current lo decreases to zero (its value at the crossing instant) and then increases.

Thus, during a step 204, the control device 110 detects the crossing instant t2 of the resonance current Ir and of the magnetizing current Im from the rectified current lo measured by the measuring device 108. Indeed, the primary current Ip and the magnetizing current Im are currents within the transformer t and therefore are generally inaccessible by measuring.

Thus, the control device 110 detects an instant when the rectified current lo is cancelled. For example, the control device 110 detects the first transition to zero of the rectified current lo. In the case whereby there would be slight oscillations around zero, only the first transition to zero is taken into account, with the others not being counted (hysteresis).

During a step 206, the control device computes a dead time duration D(N) for the current cycle N from the crossing instant t2.

For example, this crossing instant t2 is taken as the end of the dead time, so that the duration D(N) is equal to the difference between the instant t1 and the instant t2. In another example, a predefined margin is added to this difference, such that:

D(N)=t2−t0+predefined margin

In the example described, the dead time duration D(N) is then recorded in the memory 112 in order to be retrieved from this memory 112 for a subsequent cycle, for example, the kth cycle following the current cycle N, with k being an integer greater than or equal to one. For example, k is between three and ten, for example, six.

Indeed, the time taken by the control device 110 to carry out the preceding computations generally does not allow application of the dead time duration D(N) determined for the current cycle N.

Thus, in the example described, during a step 208, the control device 110 retrieves, from the memory 112, a dead time duration D(N−k) determined in the kth preceding cycle and controls the closure of the low-side switch QL at an instant t3 separate from the instant t0 of this dead time duration D(N−k). In general, the operation of the voltage converter 100 does not significantly change over a small number of cycles, so that the duration D(N) is substantially equal to the duration D(N−k).

If the computing power of the control device 110 allows, the dead time duration D(N) can be used for the current cycle.

In other embodiments, the duration D(N) can be used for several subsequent cycles.

Steps similar to steps 202 to 208 can be implemented to determine a dead time duration D′(N) during the second phase of the cycle, i.e., in the example described, between opening the high-side switch QH and closing the low-side switch QL. In FIG. 3, the same instant numbers are used for the second phase of the cycle.

In other embodiments, the duration D(N) can be used as the time duration for the second phase of the cycle (D′(N)=D(N)), i.e., in the example described, between opening the high-side switch QH and closing the low-side switch QL.

Moreover, operating points can exist where it is not necessary and/or possible (for example, because the crossing of the resonant Ir and auxiliary Im currents occurs before the cancellation of the square wave voltage Vs). In this case, a fixed and previously recorded dead time value can be used instead of attempting to use the crossing of the resonance Ir and auxiliary Im currents.

Preferably, each capacitor CH, CL is selected so that, following the command to open the switch on the other side (instant t0), this capacitor CH, CL is discharged (instant t1) before the resonance current Ir crosses the magnetizing current Im (instant t2), with this being for a predefined range of input voltages Vi and/or a predefined range of switching frequencies Fc and/or a predefined range of charges R. Within the meaning of the present invention, a range can include a single value.

Thus, with reference to FIG. 4, an example of a method 400 for manufacturing the voltage converter 100 can comprise the following steps.

During a step 402, the desired ranges of input voltages V 1 and/or of switching frequency Fc and/or of charges R are obtained.

During a step 404, a value for each capacitor CH, CL is determined so that the capacitor CH, CL is discharged (instant t1) before the current Lr reaches the current Im (instant t2), over the obtained range or even over all the obtained ranges. More specifically, the discharge time of each capacitor CH, CL depends on the value of the resonance current Ir. If the value of each capacitor CH, CL increases, the instant t1 will move away from the instant t0, and if the value of each capacitor CH or CL decreases, the instant t1 will approach the instant t0.

During a step 406, the voltage converter 100 is manufactured with the capacitors CH, CL having the determined values.

The value of the high-side capacitor CH can be determined in a similar manner, for the same desired ranges.

With reference to FIG. 5, another example of a voltage converter 500 implementing the invention will now be described.

The voltage converter 500 is similar to that of FIG. 1, except that the transformer T is not a center tap transformer and therefore does not participate in the rectification of current. The secondary of the transformer T is therefore traversed by an alternating secondary current Is. In this embodiment, the rectifier 106 comprises a full-bridge of four diodes, connected between the secondary of the transformer T and the output capacitor Co. Furthermore, the measuring device 108 is designed to measure the secondary current Is and to determine the crossing instant t2 from the measured secondary current Is.

For example, the control device 110 is designed to determine, as the crossing instant t2, an instant for changing the sign of the secondary current Is. For example, the control device 110 detects the first transition below zero. In the case whereby there would be slight oscillations around zero, only the first transition is taken into account, with the others not being counted (hysteresis).

With reference to FIG. 6, another example of a voltage converter 600 implementing the invention will now be described.

The voltage converter 600 is similar to that of FIG. 5, except that the transformer T is absent. The measuring device 108 is then designed, for example, to measure the auxiliary current Ip and the control device 110 is designed to determine the crossing instant t2 from the measured auxiliary current Ip, for example, in the same manner as described for the secondary current of the voltage converter 500.

It is clearly apparent that a voltage converter such as those described above allows the dead time duration to be determined without having to measure the midpoint voltage between the switches of the switching arm.

It also should be noted that the invention is not limited to the embodiments described above. Indeed, it will become apparent to a person skilled in the art that various modifications can be made to the embodiments described above, in the light of the teaching that has just been disclosed to them.

In the detailed presentation of the invention provided above, the terms used must not be understood to be limiting the invention to the embodiments set forth in the present description, but must be understood to include all equivalents, the anticipation of which is within the scope of a person skilled in the art by applying their general knowledge to the implementation of the teaching that has just been disclosed to them.

1. A voltage converter comprising:
a voltage conversion circuit comprising:
an inverter designed to provide a square wave voltage from a direct input voltage, the inverter comprising at least one switching arm comprising a high-side switch and a low-side switch connected together at a midpoint designed to introduce the square wave voltage;
a resonant tank comprising a resonance capacitor, resonance inductor and an auxiliary inductor,
a rectifier connected to the auxiliary inductor for rectifying an alternating current exiting the resonant tank in order to provide a rectified current;
an output capacitor designed to provide a direct output voltage from the rectified current; and
a device for controlling the switches designed to alternate a phase in which the control device opens a first one of the switches and closes a second one of the switches, and a phase in which the control device opens the second one of the switches and closes the first one of the switches, with the control device being designed to provide, between two consecutive phases, a dead time during which the two switches are open;
wherein it further comprises a device for measuring an electrical signal of the voltage conversion circuit and in that the control device is designed to determine, from the measured electrical signal, a crossing instant of the resonance current and of the auxiliary current and to compute a dead time duration from the crossing instant.

2. The voltage converter as claimed in claim 1, further comprising a transformer having a magnetizing inductor on a primary of the transformer and wherein the auxiliary inductor comprises the magnetizing inductor.

3. The voltage converter as claimed in claim 1, wherein the electrical signal is the rectified current.

4. The voltage converter as claimed in claim 3, wherein the control device is designed to determine the crossing instant by detecting an instant when the rectified current is cancelled.

5. The voltage converter as claimed in claim 1, wherein the electrical signal is the alternating current.

6. The voltage converter as claimed in claim wherein the control device is designed to determine the crossing instant by detecting an instant when the alternating current changes sign.

7. The voltage converter as claimed in claim 1, comprising capacitors respectively connected parallel to the switches.

8. A method for manufacturing a voltage converter as claimed in claim 7, comprising:
obtaining a range of switching frequencies for the switching arm;
determining values for the capacitors such that for each capacitor, after opening the side switch opposite this capacitor, this capacitor is discharged before the resonance current crosses the magnetizing current on the or even on all the switching frequencies of the obtained range; and
manufacturing the voltage converter with capacitors with the determined values.

9. A method for controlling a voltage conversion circuit comprising:
an inverter designed to provide a square wave voltage from a direct input voltage, the inverter comprising at least one switching arm comprising a high-side switch and a low-side switch, connected together at a midpoint designed to introduce the square wave voltage;
a resonant tank comprising a resonance capacitor, a resonance inductor and an auxiliary inductor;
a rectifier connected to the auxiliary inductor for rectifying an alternating current exiting the resonant tank in order to provide a rectified current;
an output capacitor designed to provide a direct output voltage from the rectified current;
wherein it comprises:
controlling the switches in order to alternate a phase in which the control device opens a first one of the switches and closes a second one of the switches, and a phase in which the control device opens the second one of the switches and closes the first one of the switches, with the control device being designed to provide, between two consecutive phases, a dead time during which the two switches are open;
measuring an electrical signal of the voltage conversion circuit;
determining, from the measured electrical signal, a crossing instant of the resonance current and of the auxiliary current; and
computing a dead time duration from the crossing instant.

10. A computer program downloadable from a communication network and/or recorded on a computer-readable medium,
wherein it comprises instructions for executing the steps of a method as claimed in claim 9, when said program is executed on a computer.

11. The voltage converter as claimed in claim 2, wherein the electrical signal is the rectified current.

12. The voltage converter as claimed in claim 2, wherein the electrical signal is the alternating current.

13. The voltage converter as claimed in claim 2, comprising capacitors respectively connected parallel to the switches.

14. The voltage converter as claimed in claim 3, comprising capacitors respectively connected parallel to the switches.

15. The voltage converter as claimed in claim 4, comprising capacitors respectively connected parallel to the switches.

16. The voltage converter as claimed in claim 5, comprising capacitors respectively connected parallel to the switches.

17. The voltage converter as claimed in claim 6, comprising capacitors respectively connected parallel to the switches.
